(19) United States
(12) Patent Application Publication
(10) Pub. No.: US 2017/0163580 A1
(43) Pub. Date: Jun. 8, 2017

(54) INTERACTIVE METHOD AND DEVICE FOR PLAYBACK OF MULTIMEDIA

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Lina ZHANG, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/242,222

(22) Filed: Aug. 19, 2016

Related U.S. Application Data
(63) Continuation of application No. PCT/CN2016/089546, filed on Jul. 10, 2016.

(30) Foreign Application Priority Data
Dec. 2, 2015 (CN) 201510874569.5

(51) Int. Cl. H04L 12/58; H04L 29/08

(52) U.S. Cl. CPC H04L 51/10; H04L 51/12; H04L 67/26

(57) ABSTRACT

Embodiments of the present disclosure provide a method and electronic device for interaction during multimedia play. The method includes: detecting a sharing request message from a first terminal, where the sharing request message includes information of a second terminal and information of to-be-shared multimedia content; sending a sharing invitation message to the second terminal according to the sharing request message, where the sharing invitation message includes the information of the to-be-shared multimedia content; acquiring a first viewing comment generated by the first terminal in response to the sharing request message; and acquiring a second viewing comment generated by the second terminal in response to the sharing invitation message; pushing the second viewing comment to the first terminal by a bullet curtain; and pushing the first viewing comment to the second terminal by the bullet curtain.

### CROSS-REFERENCE TO RELATED APPLICATIONS

The present application is a continuation of PCT application No. PCT/CN2016/089546 submitted on Jul. 10, 2016, and claims priority to Chinese Patent Application No. 2015108745695, filed with the Chinese Patent Office on Dec. 2, 2015, which is incorporated herein by reference in its entirety.

### TECHNICAL FIELD

Embodiments of the present disclosure relate to the field of video technologies, and in particular, to a method and electronic device for interaction during multimedia play.

### BACKGROUND

With popularity of computer technologies and terminal technologies, more and more video users use intelligent terminal devices (including intelligent terminal devices such as a smartphone and a tablet computer, etc.) to watch videos. During watching a video, a video user can comment on the video by a bullet curtain, and send his/her own comments on information of the watched video to a play interface of the video by the bullet curtain, so that other users can see the bullet curtain information, thereby further completing sharing of the comments on the video information.

However, in a current video play process, bullet curtain information sent by a video user cannot be shared to a particular user, and bullet curtain information acquired by the video user sent by other users cannot identify the identities of senders. Therefore, a video user cannot interact in real time with a particular user during watching a video, thereby causing lower usage experience of the video user.

### SUMMARY

An objective of the present disclosure is to provide a method and electronic device for interaction during multimedia play, so as to implement an interaction between a user and a particular person.

According to a first aspect, an embodiment of the present disclosure, a method for interaction during multimedia play is provided, including: detecting a sharing request message from a first terminal, where the sharing request message includes information of a second terminal and information of to-be-shared multimedia content; sending a sharing invitation message to the second terminal according to the sharing request message, where the sharing invitation message includes the information of the to-be-shared multimedia content; acquiring a first viewing comment generated by the first terminal on the information of the to-be-shared multimedia content; and acquiring a second viewing comment generated by the second terminal in response to the sharing invitation message; pushing the second viewing comment to the first terminal by a bullet curtain; and pushing the first viewing comment to the second terminal by the bullet curtain.

On a second aspect, according to another aspect of the present disclosure, an embodiment of the application further provides a non-volatile computer storage medium, which stores computer executable instructions, where the computer executable instructions is used to execute any of the foregoing methods for interaction during multimedia play of the application.

An apparatus for interaction during multimedia play is provided. The apparatus includes: a detection module configured to detect a sharing request message from a first terminal, where the sharing request message includes information of a second terminal and information of to-be-shared multimedia content; a sending module configured to send a sharing invitation message to the second terminal according to the sharing request message detected by the detection module, where the sharing invitation message includes the information of the to-be-shared multimedia content; an acquiring module configure to acquire, according to the sharing invitation message sent by the sending module, a first viewing comment generated by the first terminal on the information of the to-be-shared multimedia content; and to acquire a second viewing comment generated by the second terminal in response to the sharing invitation message sent by the sending module; and a push module configured to push the second viewing comment acquired by the acquiring module to the first terminal by a bullet curtain; and to push the first viewing comment acquired by the acquiring module to the second terminal by the bullet curtain.

On a third aspect, an embodiment of the application further provides an electronic device, including: at least one processor; and a memory, where the memory stores a program that can be executed by the at least one processor, and the instructions is executed by the at least one processor, so that the at least one processor can execute any of the foregoing methods for interaction during multimedia play of the application.

### BRIEF DESCRIPTION OF THE DRAWINGS

One or more embodiments are exemplarily described by figures corresponding thereto in the accompanying drawings, and the exemplary descriptions do not constitute a limitation on the embodiments. Elements with the same reference numbers in the accompanying drawings represent similar elements. Unless otherwise particularly stated, the figures in the accompanying drawings do not constitute a scale limitation.

FIG. 1 is a schematic flowchart showing a method for interaction during multimedia play according to an exemplary embodiment of the present disclosure;

FIG. 2 is a schematic structural diagram showing an apparatus for interaction during multimedia play according to an exemplary embodiment of the present disclosure;

FIG. 3 is another schematic structural diagram showing an apparatus for interaction during multimedia play according to an exemplary embodiment of the present disclosure; and

FIG. 4 is a schematic structural diagram of hardware of a device for executing a method for interaction during multimedia play according to an exemplary embodiment of the present application.

### DETAILED DESCRIPTION

A basic concept of some embodiments of the present disclosure is to provide a method and electronic device for interaction during multimedia play, which during multimedia play, by pushing a viewing comment of a first terminal to a second terminal, and pushing a viewing comment of the second terminal to the first terminal, enable a user to interact with a particular user. For example, when watching a video by using a smartphone, a user can interact with a particular user by the method.

The following describes the method and electronic device for interaction during multimedia play of exemplary embodiments of the present disclosure in detail with reference to the accompanying drawings.

### Embodiment 1

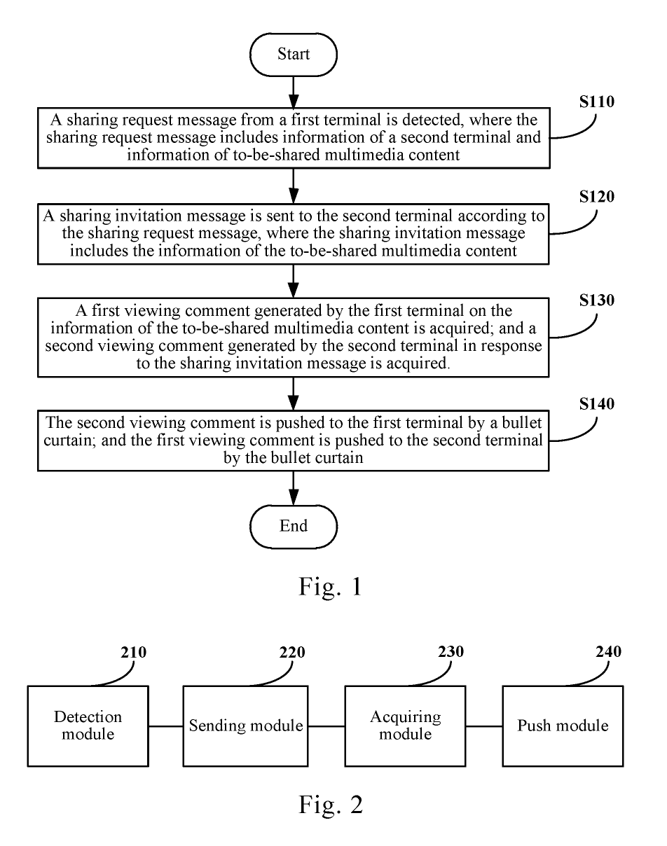

FIG. 1 shows a schematic flowchart of a method for interaction during multimedia play according to an exemplary embodiment of the present disclosure. The interaction method may be used for implementing an interaction between a user and a particular user during multimedia play, which may be executed by an interaction apparatus during multimedia play shown in FIG. 2 or an apparatus including the interaction apparatus during multimedia play shown in FIG. 2, for example, a server corresponding to play control of the multimedia.

Refer to FIG. 1, in step S110, a sharing request message from a first terminal is detected, where the sharing request message includes information of a second terminal and information of to-be-shared multimedia content.

The first terminal and the second terminal may be intelligent terminal devices used by different users for viewing multimedia content. If when a first user uses the first terminal to view the multimedia content, comments on the viewed multimedia content and needs to perform an interaction activity, for example, share, communication or the like, on the comment with a second user (a particular user, for example, a friend on a contact list of a smartphone, or a friend in a given messaging APP of a tablet computer), then the particular user needs to view the same multimedia content by the second terminal, so as to further perform the interaction activity on the foregoing comment or the multimedia content.

Specifically, when viewing a multimedia content, a first user can send a sharing request message to a server by using a sharing port of a multimedia play page, provided on a first terminal, so as to send the sharing request message including information of a second terminal and information of the viewed multimedia content to the server. The information of the second terminal is used for the server to recognize the second terminal. If the second terminal is a smartphone, the information may be a phone number corresponding to the smartphone; and if the second terminal is a tablet computer, the information may be a media access control (Media Access Control, MAC) address corresponding to the tablet computer.

The information of the to-be-shared multimedia content includes a link address of the to-be-shared multimedia content and/or a tag of the to-be-shared multimedia content. The link address of the to-be-shared multimedia content may be, for example, http://v.AAA.com/301989888&87#, or the tag of the to-be-shared multimedia content may be, for example, episode 1 of Nirvana in Fire, etc.

In step S120, a sharing invitation message is sent to the second terminal according to the sharing request message, where the sharing invitation message includes the information of the to-be-shared multimedia content.

After receiving the sharing request message sent by the first terminal, the server can send the sharing invitation message to the second terminal according to the information of the second terminal in the sharing request message, and send the information of the to-be-shared multimedia content in the sharing request message to the second terminal. The second user can receive the sharing invitation message by the second terminal, and view the corresponding multimedia content according to the information of the to-be-shared multimedia content in the sharing invitation message.

In step S130, a first viewing comment generated by the first terminal on the information of the to-be-shared multimedia content is acquired; and a second viewing comment generated by the second terminal in response to the sharing invitation message is acquired.

When the second user uses the second terminal to receive the sharing invitation message sent by the server and view the foregoing multimedia content, the first user and the second user view the same multimedia content at the same time. At this time, the first user can use the first terminal to comment on the multimedia content, and the first terminal generates the first viewing comment and sends it to the server; and the second user can use the second terminal to comment on the multimedia content, and the second terminal generates the second viewing comment and sends it to the server. The server can acquire the first viewing comment and the second viewing comment and perform corresponding processing.

In step S140, the second viewing comment is pushed to the first terminal by a bullet curtain; and the first viewing comment is pushed to the second terminal by the bullet curtain.

After acquiring the first viewing comment and the second viewing comment, the server can acquire information of the first terminal and the second terminal, and push the second viewing comment to the first terminal and push the first viewing comment to the second terminal according to the information of the first terminal and the second terminal, allowing the first user to view the second viewing comment and the second user to view the first viewing comment, and thereby enabling the interaction activity to be performed.

Specifically, a push manner of the first viewing comment and the second viewing comment may be: displaying the second viewing comment on a first multimedia play window of the first terminal for the first user to view; and displaying the first viewing comment on a first multimedia play window of the second terminal for the second user to view. In this way, the first user and the second user can interact synchronously during the multimedia play, thereby greatly improving user experience.

In addition, after the server acquires a correspondence between the first terminal and the second terminal, the acquired viewing comments of the first user and the second user on the same multimedia can be directly pushed to the second terminal or the first terminal, so as to allow the first user or the second user to interact conveniently and quickly.

Preferably, the to-be-shared multimedia content includes audio and a video.

Preferably, the first viewing comment and the second viewing comment respectively include at least one of the following content: a word, a figure, or audio.

In this embodiment, the first viewing comment and the second viewing comment may include a word, a figure, and audio, and a manner of combining the word, the figure, and the audio can facilitate the user to perform the interaction activity, and increase interest of the interaction activity, thereby increasing usage experience of the user.

Preferably, the interaction method further includes: block viewing comments of other terminals on the to-be-shared multimedia content.

If bullet curtain information from multiple other users appear in a play interface of a video when a first user watches the video, this may affect the first user to watch the video and interact with a second user. However, turning off a switch widget of bullet curtain may turn off all bullet curtain information. Therefore, the first user cannot acquire bullet curtain information from the second user. The method in this embodiment can block the bullet curtain information from other users, so that the interaction activity between the first user and the second user can be performed more successfully.

Preferably, the interaction method further includes: skipping pushing the first viewing comment and the second viewing comment to other terminals, so that the first user and the second user can perform the interaction activity in a safe environment when the first viewing comment and the second viewing comment relate to personal privacy.

According to the method for interaction during multimedia play in this embodiment of the present disclosure, a sharing invitation message is sent to a second terminal according to a sharing request message of a first terminal about multimedia content, and viewing comments of the first terminal and the second terminal on the same multimedia are pushed to each other, thereby implementing an interaction between a user and a particular user during multimedia play.

### Embodiment 2

FIG. 2 is a schematic structural diagram showing an apparatus for interaction during multimedia play according to an exemplary embodiment of the present disclosure, and the interaction apparatus may be used for executing the method for interaction during multimedia play shown in Embodiment 1 of the present disclosure.

Referring to FIG. 2, the apparatus for interaction during multimedia play includes a detection module 210, a sending module 220, an acquiring module 230, and a push module 240.

The detection module 210 is configured to detect a sharing request message from a first terminal, where the sharing request message includes information of a second terminal and information of to-be-shared multimedia content.

The sending module 220 is configured to send a sharing invitation message to the second terminal according to the sharing request message detected by the detection module 210, where the sharing invitation message includes the information of the to-be-shared multimedia content.

The acquiring module 230 is configure to acquire, according to the sharing invitation message sent by the sending module 220, a first viewing comment generated by the first terminal on the information of the to-be-shared multimedia content; and to acquire a second viewing comment generated by the second terminal in response to the sharing invitation message sent by the sending module 220.

The push module 240 is configured to push the second viewing comment acquired by the acquiring module 230 to the first terminal by a bullet curtain; and to push the first viewing comment acquired by the acquiring module 230 to the second terminal by the bullet curtain.

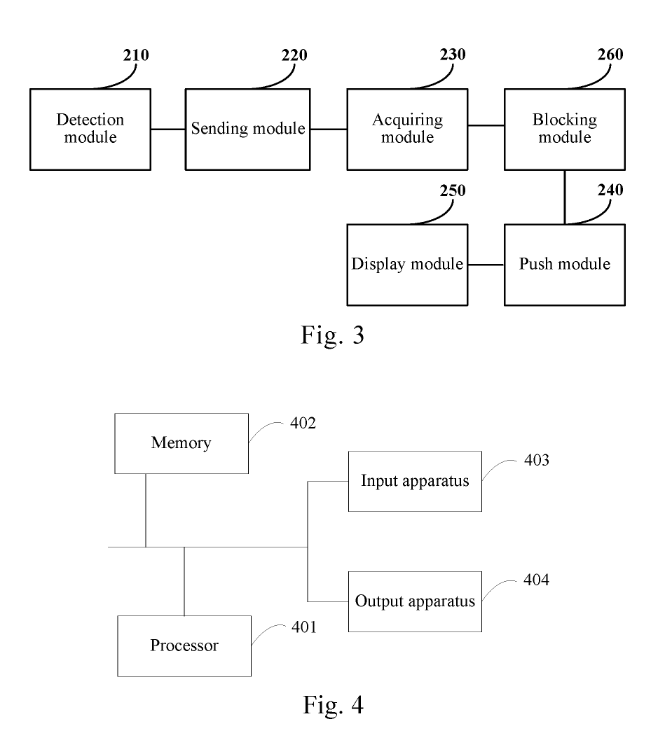

In an embodiment, on the basis of the embodiment shown in FIG. 2, an apparatus for interaction during multimedia play in another embodiment shown in FIG. 3 further includes a display module 250 configured to display the second viewing comment pushed by the push module 240 on a first play window of the first terminal; and to display the first viewing comment pushed by the push module 240 on a second play window of the second terminal.

In an embodiment, the to-be-shared multimedia content includes audio and/or a video.

In an embodiment, the apparatus for interaction during multimedia play further includes a blocking module 260 configured to block viewing comments of other terminals on the to-be-shared multimedia content, and/or to skip pushing the first viewing comment and the second viewing comment to other terminals.

The apparatus for interaction during multimedia play in this embodiment of the present disclosure, by pushing a viewing comment of a first user on a first terminal on multimedia to a second user, and pushing a viewing comment of a second user on a second terminal on the multimedia to the first user, implements an interaction between a user and a particular user during multimedia play.

It should be noted that according to the needs of implementations, each part/step described in this application may be divided into more parts/steps, and two or more parts/steps or some operations of parts/steps may be combined into a new part/step, so as to achieve the objective of the present disclosure.

### Embodiment 3

Embodiment 3 of the application provides a non-volatile computer storage medium, which stores computer executable instructions, where the computer executable instructions can execute the method for interaction during multimedia play of any of the foregoing method embodiments of the application.

### Embodiment 4

FIG. 4 is a schematic structural diagram of hardware of a device for executing a method for interaction during multimedia play provided by Embodiment 4 of the application. As shown in FIG. 4, the device includes: one or more processors 401 and a memory 402, with one processor 401 as an example in FIG. 4.

A device for executing the method for interaction during multimedia play may further include: an input apparatus 403 and an output apparatus 404.

The processor 401, the memory 402, the input apparatus 403, and the output apparatus 404 can be connected by means of a bus or in other manners, with a connection by means of a bus as an example in FIG. 4.

As a non-volatile computer readable storage medium, the memory 402 can be used to store non-volatile software programs, non-volatile computer executable programs and modules, for example, program instructions/module corresponding to the method for interaction during multimedia play in the embodiments of the application (for example, a detection module 210, a sending module 220, an acquiring module 230, and a push module 240shown in FIG. 2). The processor 401 executes various functional applications and data processing of the server, that is, implements the method for interaction during multimedia play of the foregoing method embodiments, by running the non-volatile software programs, instructions, and modules stored in the memory 402.

The memory 402 may include a program storage area and a data storage area, where the program storage area may store an operating system and at least one application needed by function; the data storage area may store data created according to use of an apparatus for interaction during multimedia play, and the like. In addition, the memory 402 may include a high-speed random access memory, and also may include a non-volatile memory, such as at least one disk storage device, flash storage device, or other non-volatile solid-state storage devices. In some embodiments, the memory 402 optionally includes memories remotely disposed with respect to the processor 401, and the remote memories may be connected, via a network, to the apparatus for interaction during multimedia play. Examples of the foregoing network include but are not limited to: the Internet, an intranet, a local area network, a mobile communications network, and a combination thereof.

The input apparatus 403 can receive entered digit or character information, and generate key signal inputs relevant to user setting and functional control of the apparatus for interaction during multimedia play. The output apparatus 404 may include a display device, for example, a display screen, etc.

The one or more modules are stored in the memory 402, and execute the method for interaction during multimedia play in any one of the foregoing method embodiments when being executed by the one or more processors 401.

The foregoing product can execute the method provided in the embodiments of the application, and has corresponding functional modules for executing the method and beneficial effects. The method provided in the embodiments of the application can be referred to for technical details that are not described in detail in the embodiment.

The electronic device in the embodiment of the application exists in multiple forms, including but not limited to:

(1) Mobile communication device: such devices being characterized by having a mobile communication function and a primary objective of providing voice and data communications; such type of terminals including a smart phone (for example, an iPhone), a multimedia mobile phone, a feature phone, a low-end mobile phone, and the like;

(2) Ultra mobile personal computer device: such devices belonging to a category of personal computers, having computing and processing functions, and also generally a feature of mobile Internet access; such type of terminals including PDA, MID and UMPC devices, and the like, for example, an iPad;

(3) Portable entertainment device: such devices being capable of display and play multimedia content; such type of devices including an audio and video player (for example, an iPod), a handheld game console, an e-book, an intelligent toy and a portable vehicle-mounted navigation device;

(4) Server: a device that provides a computing service; the components of the server including a processor, a hard disk, a memory, a system bus, and the like; an framework of the server being similar to that of a general-purpose computer, but higher demanding in aspects of processing capability, stability, reliability, security, extensibility, manageability or the like due to a need to provide highly reliable services; and

(5) Other electronic apparatuses having a data interaction function.

The apparatus embodiments described above are merely schematic, and the units described as separated components may or may not be physically separated; components presented as units may or may not be physical units, that is, the components may be located in one place, or may be also distributed on multiple network units. Some or all modules therein may be selected according to an actual requirement to achieve the objective of the solution of the embodiment.

Through descriptions of the foregoing implementation manners, a person skilled in the art can clearly recognize that each implementation manner can be implemented by means of software in combination with a general-purpose hardware platform, and certainly can be also implemented by hardware. Based on such an understanding, the essence or a part contributing to the relevant technologies of the foregoing technical solutions can be embodied in the form of a software product. The computer software product may be stored in a computer readable storage medium, for example, a ROM/RAM, a magnetic disk, a compact disc or the like, including several instructions for enabling a computer device (which may be a personal computer, a sever, or a network device, and the like) to execute the method described in the embodiments or in some parts of the embodiments.

Finally, it should be noted that the foregoing embodiments are only for the purpose of describing the technical solutions of the application, rather than limiting thereon. Although the application has been described in detail with reference to the foregoing embodiments, a person of ordinary skill in the art should understand that he/she can still modify technical solutions disclosed in the foregoing embodiments, or make equivalent replacements to some technical features therein, while such modifications or replacements do not make the essence of corresponding technical solutions depart from the spirit and scope of the technical solutions of the embodiments of the application.

What is claimed is:

1. A method for interaction during multimedia play applied in a terminal, comprising:
detecting a sharing request message from a first terminal, wherein the sharing request message comprises information of a second terminal and information of to-be-shared multimedia content;
sending a sharing invitation message to the second terminal according to the sharing request message, wherein the sharing invitation message comprises the information of the to-be-shared multimedia content;
acquiring a first viewing comment generated by the first terminal on the information of the to-be-shared multimedia content; and acquiring a second viewing comment generated by the second terminal in response to the sharing invitation message; and
pushing the second viewing comment to the first terminal by a bullet curtain; and
pushing the first viewing comment to the second terminal by the bullet curtain.

2. The method according to claim 1, where the method further comprises:
displaying the second viewing comment on a first play window of the first terminal; and
displaying the first viewing comment on a second play window of the second terminal.

3. The method according to claim 1, wherein the to-be-shared multimedia content comprises audio and/or a video.

4. The method according to claim 1, wherein the information of the to-be-shared multimedia content comprises a link address of the to-be-shared multimedia content and/or a tag of the to-be-shared multimedia content.

5. The method according to claim 1, where the method further comprises:
blocking viewing comments of other terminals on the to-be-shared multimedia content.

6. The method according to claim 1, where the method further comprises:
skipping pushing the first viewing comment and the second viewing comment to other terminals.

7. A non-volatile computer storage medium, stored with computer executable instructions that, when executed by an electronic device, cause the electronic device to:
detect a sharing request message from a first terminal, wherein the sharing request message comprises information of a second terminal and information of to-be-shared multimedia content;
send a sharing invitation message to the second terminal according to the sharing request message, wherein the sharing invitation message comprises the information of the to-be-shared multimedia content;
acquire a first viewing comment generated by the first terminal on information of the to-be-shared multimedia content; and acquire a second viewing comment generated by the second terminal in response to the sharing invitation message; and
push the second viewing comment to the first terminal by a bullet curtain; and pushing the first viewing comment to the second terminal by the bullet curtain.

8. The non-volatile computer storage medium according to claim 7, wherein the electronic device is further caused to:
display the second viewing comment on a first play window of the first terminal, and display the first viewing comment on a second play window of the second terminal.

9. The non-volatile computer storage medium according to claim 7, wherein the to-be-shared multimedia content comprises audio and/or a video.

10. The non-volatile computer storage medium according to claim 7, wherein the information of the to-be-shared multimedia content comprises a link address of the to-be-shared multimedia content and/or a tag of the to-be-shared multimedia content.

11. The non-volatile computer storage medium according to claim 7, wherein the electronic device is further caused to:
block viewing comments of other terminals on the to-be-shared multimedia content.

12. The non-volatile computer storage medium according to claim 7, wherein the electronic device is further caused to:
skip pushing the first viewing comment and the second viewing comment to other terminals.

13. An electronic device, comprising:
at least one processor; and
a memory in communication connection with the at least one processor, wherein
the memory stores instructions that can be executed by the at least one processor,
wherein execution of the instructions by the said at least one processor causes the at least one processor to:
detect a sharing request message from a first terminal, wherein the sharing request message comprises information of a second terminal and information of to-be-shared multimedia content;
send a sharing invitation message to the second terminal according to the sharing request message, wherein the sharing invitation message comprises the information of the to-be-shared multimedia content;
acquire a first viewing comment generated by the first terminal on the information of the to-be-shared multimedia content; and acquire a second viewing comment generated by the second terminal in response to the sharing invitation message; and
push the second viewing comment to the first terminal by a bullet curtain; and push the first viewing comment to the second terminal by the bullet curtain.

14. The electronic device according to claim 13, wherein the at least one processor is further caused to:
display the second viewing comment on a first play window of the first terminal; and display the first viewing comment on a second play window of the second terminal.

15. The electronic device according to claim 13, wherein the to-be-shared multimedia content comprises audio and/or a video.

16. The electronic device according to claim 13,wherein the information of the to-be-shared multimedia content comprises a link address of the to-be-shared multimedia content and/or a tag of the to-be-shared multimedia content.

17. The electronic device according to claim 13, wherein the at least one processor is further caused to:
block viewing comments of other terminals on the to-be-shared multimedia content.

18. The electronic device according to claim 13, wherein the at least one processor is further caused to:
skip pushing the first viewing comment and the second viewing comment to other terminals.
